(19) United States
(12) Patent Application Publication
(10) Pub. No.: US 2013/0188961 A1
(43) Pub. Date: Jul. 25, 2013

(54) HYBRID SYSTEM FOR DISTRIBUTING BROADBAND WIRELESS SIGNALS INDOORS

(71) Applicants: Luis Cucala Garcia, Madrid (ES); Wsewolod Warzanskyj García, Madrid (ES); Pedro Olmos González, Madrid (ES)

(72) Inventors: Luis Cucala Garcia, Madrid (ES); Wsewolod Warzanskyj García, Madrid (ES); Pedro Olmos González, Madrid (ES)

(73) Assignee: TELEFONICA, S.A., Madrid (ES)

(21) Appl. No.: 13/704,832

(22) PCT Filed: Jun. 15, 2011
(86) PCT No.: PCT/EP2011/059889

§ 371 Date: Apr. 8, 2013

(30) Foreign Application Priority Data
Jun. 15, 2010 (ES) P201030924

(51) Int. Cl. H04B 10/114

(52) U.S. Cl. CPC H04B 10/114
USPC 398/115

(57) ABSTRACT

The invention relates to a system (100 200) for distributing broadband wireless signals indoors, comprising: a radio access node (101 201) connected to a telecommunications access network through an access interface (107 207), wherein said radio access node comprises a broadband signal transmission/reception module configured to transmit and receive VHF/UHF DVB-T broadband wireless signals through a broadband radio interface; and at least one piece of client equipment (102 202) comprising a broadband signal transmission/reception module configured to transmit and receive VHF/UHF DVB-T broadband wireless signals through a broadband radio interface in the 5 GHz free band, wherein said 5 GHz free band is the one specified in the ETSI EN 301 893 standard. The system further comprises: at least one optical device (105 205 300) configured to: receive broadband signals from said radio access node (101 201), select at least one broadband signal from said radio access node (101 201), convert said broadband signal into an optical signal and transmit said optical signal through a link over plastic optical fiber (108 208); and at least one transmitting device (109 209 600) configured to: receive and detect an optical signal from said at least one optical device (105 205 300) through said link over plastic optical fiber (108 208), convert said optical signal into a DVB-T signal in the 5 GHz free band and transmit it through a broadband radio interface in the 5 GHz free band.

### FIELD OF THE INVENTION

The present invention applies to the telecommunications field and, more specifically, to the construction and deployment of communications networks inside buildings and their connection with other telecommunications networks.

### BACKGROUND OF THE INVENTION

The technique conventionally used to provide radio communications interfaces inside buildings consists of the installation of as many pieces of equipment as interfaces are necessary. These pieces of equipment must be configured by the user himself and cannot be upgraded to changes in the communications standard that they use. These pieces of equipment furthermore do not assure the coverage in any enclosure and cannot be remotely supervised and controlled from the network of the operator, so they require the local configuration thereof by the user.

Some examples of these pieces of equipment are:
A piece of equipment which allows the access to the telecommunications network by means of the copper pair cable and the ADSL interface and which, inside the home, gives support to a wireless network of the IEEE 802.11x (WiFi, Wireless Fidelity) type, which wireless network must be configured by the user himself and which cannot be supervised by the telecommunications operator.
A television over internet protocol IP (IPTV) decoder (also known as a set-top-box) which offers DVB-IP type signals to a television set and which is connected by means of a cable to an ADSL router allowing it to communicate with the telecommunications network.
A system for distributing wireless signals in the home based on IEEE 802.11x (WiFi) rerouters, which must be locally configured by the user himself and which cannot be remotely supervised from the network of the telecommunications operator.

On the other hand, all these pieces of equipment are aimed at transporting signals of the digital type, which must be recoded when it passes from one transmission medium to another, such as for example when an IPTV type signal is received from the ADSL type access network and must be encapsulated in a IEEE 802.11 frame to be transmitted by radio, which increases the equipment costs.

There are also pieces of equipment which allow transmitting signals by means of cable support in the home, although they are generally aimed at transporting digital signals. Some examples of these pieces of equipment are:
A piece of equipment using the Ethernet over twisted-pair cable, of the UTP (Unshielded Twisted Pair) type, or Ethernet over coaxial cable interface.
A piece of equipment using the PLC (Power Line Communication) interface over the domestic 220 volt power line.
A piece of equipment using the Ethernet over Plastic Optical Fiber (POF) standard.
A piece of equipment transporting analog signals, of a very low frequency and for industrial applications, over plastic optical fiber.

In the field of transmission over optical fiber in buildings, the ongoing lines of research are focused on the following activities:
[Project FP7 BONE (Building the Future Optical Network in Europe), http://www.ict-bone.eu/portal/landing_pages/index.html, FP7-ICT-2007-1216863], which works in the field of optical networks. Its report [“Report on Y2 activities and new integration strategy”], distributed on Jan. 15, 2010, mentions the following relevant activities for this invention:

Section 4.8 describes activities of Radio-over-Fiber, for single-mode and multimode fibers, although plastic fibers are not studied among the multimode fibers.

Section 4.9 describes activities of optical networks over plastic optical fiber, although only for digital communications.

[Project EU FP7 ALPHA (Architectures for Flexible Photonic Home and Access networks), http://www.ict-alpha.eu/, Grant Agreement No. 212352], which works in the field of access networks and indoor networks over optical fiber. This project analyzes the use of plastic optical fiber for transporting digital signals, but not radio signals. For example: its public report [D3.1 “Requirements and Architectural Options for Broadband In-Building Networks supporting Wired and Wireless Services”, section 5.2.4 “Optical point to point link to antenna site using Radio-over-Fibre”], describes the use of radio-over-fiber techniques to transport UWB (Ultra Wideband) type signals over multi-mode silicon, not plastic, fibers.

There are work groups, for example DTU Fotonik (Department of Photonics Engineering, Technical University of Denmark), which have published works on the transmission of digital signals over plastic optical fiber with the name of Radio-over-Fiber, when the activity performed does not really consist of the transmission of radio signals over plastic optical fiber. For example, in [“5 GHz 200 Mbit/s Radio Over Polymer Fiber Link with Envelope Detection at 650 nm Wavelength”, Communication Conference, OFC'09, San Diego, Calif., U.S.A., 2009], a system is described in which a 5 GHz carrier is modulated with a data signal at the rate of 200 Mbit/s. However, when this modulated 5 GHz signal attacks an RC-LED diode, the latter acts as a low-pass filter and takes only the 200 Mbit/s data signal, such that the modulated optical signal which is injected into the plastic optical fiber does not contain the 5 GHz radiofrequency component. Another work by the same group [Convergencia de Sistemas de comunicación ópticos e inalámbricos” (Convergence of optical and wireless communication systems), Sociedad Española de Óptica, Óptica Pura y Aplicada 42 (2) 83-81 (2009), sections 4 and 8] describes different options of radio-over-silicon fiber systems, but the possibility of using plastic optical fiber is not considered.

Other work groups, such as the Cobra Institute (Eindhoven University of Technology) have developed a technique [In-house networks using multimode polymer optical fiber for broadband wireless Access”, Ton Koonen et al, Photonic Network Communications, 5:2, 177-187, 2003, Cobra Institute, Eindhoven University of Technology] for transporting radio frequency and microwave signals over multimode fibers, including plastic fibers, but these techniques require the use of graded-index perfluorinated polymer plastic fiber, more expensive than the simple step-index PMMA type fibers, and with a more complex connectorization, and furthermore requiring a tunable laser diode, Mach-Zehnder type optical modulators and periodic optical filters, which gives rise to the cost thereof being very high.

[Project EU FP7 POF-PLUS “Plastic Optical Fiber for Pervasive Low-cost Ultra-high capacity systems”, http://www.ict-pof-plus.eu/ Grant Agreement No.:224521], the objective of which is to develop a technique for transmitting digital signals with speeds of the order of 1 Gbit/s over different types of plastic fiber, and Radio-over-Fiber techniques, initially for transporting UWB type signals, over graded-index perfluorinated polymer type plastic optical fibers, although activities for transporting radio signals over step-index PMMA type fiber are not contemplated.

With the current technology, these pieces of equipment and these deployment techniques have limitations which are described below:
It is not possible to assure the radio coverage in all the enclosures.
It is necessary for the user to manually configure the pieces of equipment.
It is not possible to assure the remote supervision of all the pieces of equipment from the network of the telecommunications operator.
It is not possible to assure the quality of the offered service.
The existence of at least as many pieces of equipment as communications interfaces to be arranged is necessary, with the consequent accumulation of pieces of equipment and increase of costs.
The implementation of each piece of equipment is expensive, since it is necessary to perform format conversions of the digital signals which are being transported.
The pieces of equipment are specific for each radio standard and cannot be upgraded, such that in the event of improvements of the standard or the appearance of new standards it is necessary to dispense with the pieces of equipment and acquire new ones.
In some cases, the provision of the service requires the use of a cabled connection with a high cost, and which must be installed by a specialized technician.
Additionally, in the event that it is necessary to use cabled connections, these are connections over a metal conductor, such that they cannot be installed sharing the laying of the electric power cables existing in the building, in order to prevent electrical safety problems. This involves carrying out a specific laying and an increase of the costs.
In the event of using a cabled plastic fiber connection, which can share the laying with the electric power cables, the plastic fibers and the corresponding low-cost optical transceivers available on the market of the step-index PMMA (Polymethyl Methacrylate) type only allow transmitting signals with a bandwidth limited to about 100 MHz for distances of several tens of meters, which makes them unsuitable for supporting broadband wireless signals.

### SUMMARY OF THE INVENTION

The object of the present invention is to solve the aforementioned problems by means of a system for distributing radio signals and, particularly, high-definition television signals indoors, assuring the full coverage from a single radiant point, allowing the remote supervision and configuration of all the equipment used and assuring the quality of the service, furthermore allowing upgrades to new standards without needing changes in the equipment. Furthermore, the present invention allows installing the piece of radio transmitting equipment at the optimal point to assure the coverage, regardless of the location of the access interface of the telecommunications operator, by means of the connection of the piece of radio transmitting equipment to said access interface with a link over plastic fiber.

In a first aspect of the invention, a system is described for distributing broadband wireless signals indoors comprising: a radio access node connected to a telecommunications access network through an access interface, wherein said radio access node comprises a broadband signal transmission/reception module configured to transmit and receive VHF/UHF DVB-T broadband wireless signals through a broadband radio interface; and at least one piece of client equipment comprising a broadband signal transmission/reception module configured to transmit and receive VHF/UHF DVB-T broadband wireless signals through a broadband radio interface in the 5 GHz free band, wherein said 5 GHz free band is the one specified in the ETSI EN 301 893 standard. The system further comprises: at least one optical device configured to: receive broadband signals from said radio access node, select at least one broadband signal from said radio access node, convert said broadband signal into an optical signal and transmit said optical signal through a link over plastic optical fiber; and at least one transmitting device configured to: receive and detect an optical signal from said at least one optical device through said link over plastic optical fiber, convert said optical signal into a DVB-T signal in the 5 GHz free band and transmit it through a broadband radio interface in the 5 GHz free band.

Preferably, the system further comprises: a control channel configured to exchange control signals between said at least one piece of client equipment and said at least one piece of transmitting equipment over a control radio interface, each of said pieces of client equipment and at least one piece of transmitting equipment comprising a control signal transmission/reception module configured to set up said control channel for transmitting and receiving wireless signals over said control radio interface; a return channel configured to exchange the information contained in said control signals between said at least one piece of transmitting equipment and said at least optical device, each of said pieces of transmitting equipment and at least one optical device comprising an optical signal transmission/reception module configured to set up said return channel over a link over optical fiber; and a user control interface in said at least one piece of client equipment which allows a user to select from said at least one piece of client equipment a determined channel from those contained in the signal received by the radio access node.

In a possible embodiment, the piece of client equipment is connected to a piece of end equipment through an end equipment interface, said piece of client equipment being configured to provide said piece of end equipment with at least one communications service through said end equipment interface.

The control signals transmitted over said control channel preferably comprise at least one of the following types of information: a scanning initiation order, indicating to the optical device to initiate a scanning of channels contained in the signal received by the radio access node; a scanning continuation order, indicating to the optical device to tune a new channel, wherein said scanning continuation order is indicated by a user through the user control interface; a channel list generated in the piece of client equipment, wherein said channel list is stored in the piece of client equipment and in the control signal transmission/reception module of the piece of transmitting equipment and is sent to the optical device; and a tuning order for tuning a specific channel, indicating to the optical device to tune a determined channel from those contained in the signal received by the radio access node, wherein said tuning order is indicated by a user through the user control interface.

Optionally, said optical device is connected to said radio access node by means of a cable, as an insertable module or as a functional unit integrated in said radio access node. In a particular embodiment, the optical device comprises: an analog tuner, configured to select at least one of the channels included in the broadband signal delivered by the radio access node and deliver at its output a signal comprising said selected channel converted to a determined intermediate frequency; an amplitude modulator, configured to vary the amplitude of the polarization current of a light source with said signal converted to an intermediate frequency delivered at the output of said analog tuner; a transmitter for plastic optical fiber, configured to transmit an optical signal from said light source modulated with said amplitude modulator over a link of plastic optical fiber; a receiver for plastic optical fiber, configured to receive an optical signal delivered by a link over plastic optical fiber and detect the information contained in said return channel; and a control module, configured to receive a digital signal from said receiver for optical fiber and transmit said information to said analog tuner over a tuner control interface.

In a particular embodiment, the transmitting device comprises: a receiver for plastic optical fiber, configured to receive an optical signal delivered by a link over plastic optical fiber, detect said optical signal and convert it into an electric signal at a determined intermediate frequency; an image band rejection mixer, configured to convert said signal at a determined intermediate frequency in a DVB-T signal in the 5 GHz free band; a phase locked loop synthesizer with a local oscillator, configured to generate a signal, synthesize a determined frequency for said signal and inject said signal into the input of said image band rejection mixer; a radio frequency amplifier, configured to raise the amplitude of said DVB-T signal in the 5 GHz free band; a control signal transmission/reception module, configured to set up the return channel and manage said phase locked loop synthesizer with said local oscillator; an amplitude modulator configured to vary the amplitude of the polarization current of a light source with a signal delivered by said control signal transmission/reception module; and a transmitter for plastic optical fiber, configured to transmit an optical signal from said light source modulated with said amplitude modulator over a link of plastic optical fiber.

Optionally, the transmitting device further comprises a band-pass filter, configured to eliminate the signals of the local oscillator and the resulting image band of the output of said image band rejection mixer.

### BRIEF DESCRIPTION OF THE DRAWINGS

For the purpose of aiding to better understand the features of the invention according to a preferred practical embodiment thereof and to complement this description, a set of illustrative and non-limiting drawings is attached as an integral part thereof. In these drawings:

FIG. 1 shows the embodiment scenario of the invention, in which the system and the elements forming it are illustrated in a general manner.

FIG. 2 shows the embodiment scenario of the invention, in which the system and the elements forming it are illustrated in detail.

FIG. 3 shows the optical device or optical extender and the elements and interfaces that it comprises.

FIG. 4 shows a preferred embodiment of the analog tuner comprised in the optical extender.

FIG. 5 shows a preferred embodiment of the amplitude modulator comprised in the optical extender.

FIG. 6 shows the 5 GHz DVB-T transmitter and the elements and interfaces that it comprises.

FIG. 7 shows a preferred embodiment of the amplitude modulator comprised in the 5 GHz DVB-T transmitter.

FIG. 8 shows a graph representing the image band rejection as a function of the phase and amplitude errors of the quadrature signals.

FIG. 9 shows a possible embodiment of the image band rejection mixer comprised in the 5 GHz DVB-T transmitter based on intermediate frequency quadrature DVB-T signals.

FIG. 10 shows an implementation of the intermediate frequency quadrature signals by means of Bessel filters.

FIG. 11 shows the 90° hybrid implemented by means of branch line type tracks.

FIG. 12 shows a graph representing the amplitude error for specific values of the Bessel filter elements.

FIG. 13 shows a graph representing the phase error for specific values of the Bessel filter elements.

FIG. 14 shows a possible embodiment of the image band rejection mixer comprised in the 5 GHz DVB-T transmitter based on quadrature signals of the local oscillator.

FIG. 15 shows a graph representing the amplitude error for the embodiment of the image band rejection mixer with a phase shift of the local oscillator.

FIG. 16 shows a graph representing the phase error for the embodiment of the image band rejection mixer with a phase shift of the local oscillator.

### DETAILED DESCRIPTION OF THE INVENTION

Throughout this specification, the term “comprises” and its derivatives must not be interpreted in an excluding or limiting sense, i.e., it must not be interpreted in the sense of excluding the possibility of the element or concept that it refers to including additional elements or steps.

The present invention relates to a system configured to distribute audio and video signals indoors, assuring the coverage by means of using a hybrid radio and cabled technique for distributing signals which uses, when necessary, the analog transmission of radio frequency signals over plastic optical fiber, POF.

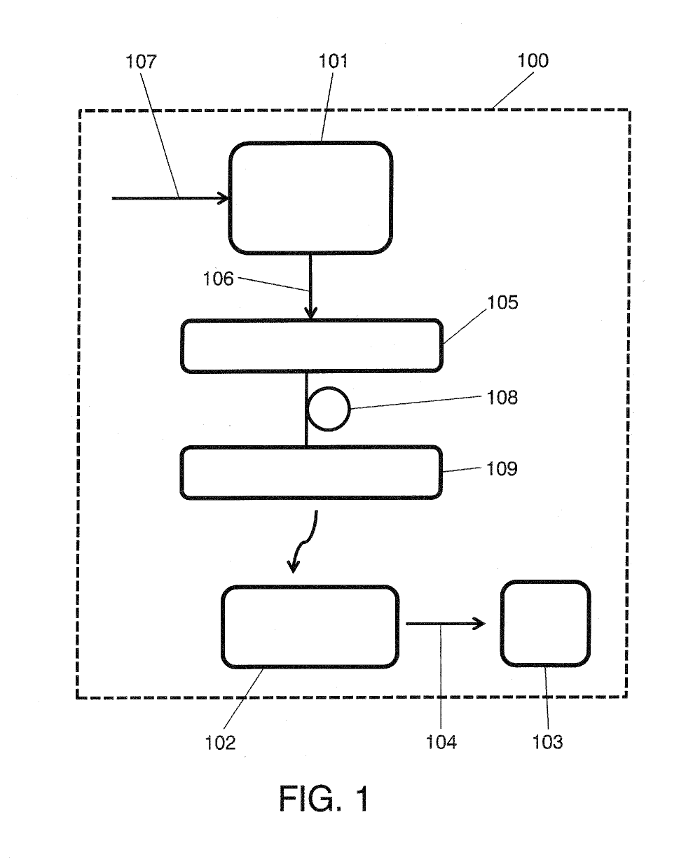

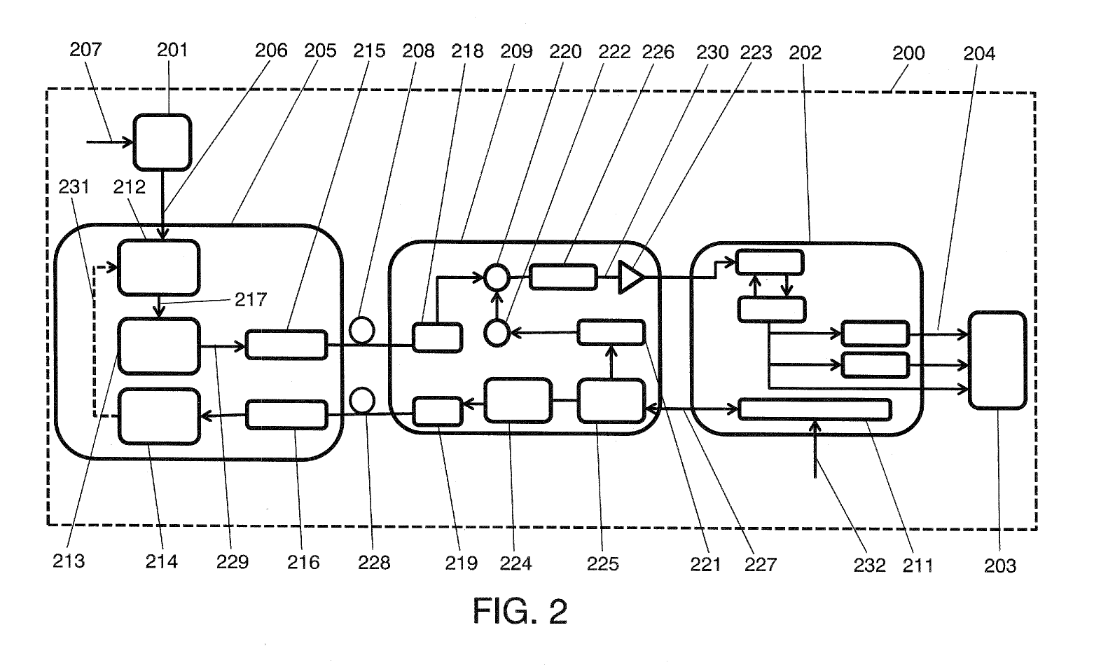

FIG. 1 and FIG. 2 illustrate a general and more detailed diagram, respectively, of a possible embodiment of the system for distributing broadband signals of the invention. The system 100 200 is especially designed for being used inside buildings and for supporting multiple radio communications interfaces inside a building. The system 100 200 comprises the following elements:
A radio access point or node 101 201, also called radio gateway, connected to a telecommunications network by means of an access interface 107 207. This radio access node 101 201 can also be a piece of optical network termination, ONT (Optical Network Termination), equipment. The radio access node 101 201 comprises a radio transmission/reception module for broadband signals in general and, in particular, for multiple audio and video signals according to the Digital Video Broadcast-Terrestrial, DVB-T, standard, in the VHF/UHF (Very High Frequency/Ultra High Frequency) radio frequency bands
One or several pieces of client or intermediate equipment 102 202. Each piece of client or intermediate equipment 102 202 comprises a broadband radio transmission/reception module and a control radio transmission/reception module 211.

The pieces of client or intermediate equipment 102 202 are designed to provide a respective piece of end equipment 103 203 with an end equipment interface 104 204, so that this piece of end equipment 103 203 can support the provision of a determined service. These pieces of end equipment 103 203 are, for example, the pieces of electronic equipment of user consumption. By way of an example, in no case in a limiting manner, these pieces of end equipment 103 203 can be a television set, a digital television decoder, a multimedia hard disk drive or a DVD type player. Also by way of an example, and without excluding other embodiments, the end equipment interface 104 204 can be an Ethernet interface, an HDMI interface, a USB interface, etcetera.
An optical device 105 205, also referred to as a piece of optical extender equipment, which by way of an example and in no case in a limiting manner, can be an independent piece which is connected to the radio access node 101 201 or to the ONT by means of a cable, an independent piece of equipment which is connected to the radio access node 101 201 or to the ONT as an insertable module or a functional unit integrated in the radio access node 101 201 or the ONT and comprising: one or several analog tuners 212, an amplitude modulator 213, a control module 214, a transmitter for plastic optical fiber 215 and a receiver for plastic optical fiber 216.

The piece of optical extender equipment 105 205 is configured to select one or several of the received signals 106 206 from the radio access node 101 201 by means of one or several analog tuners 212, which deliver at their output a signal converted to a fixed intermediate frequency 217. In a preferred embodiment of the present invention, said signal 217 is a DVB-T signal and said intermediate frequency is, for example, 36 MHz.

The piece of optical extender equipment 105 205 uses said signal at a determined intermediate frequency 217 to analogically modulate an optical transmitter 215 for optical fiber and transmit an optical signal through a link of plastic optical fiber 108 208.
A piece of 5 GHz DVB-T transmitting equipment 109 209, comprising a receiver for plastic optical fiber 218, a transmitter for plastic optical fiber 219, an image band rejection mixer 220, a PLL (Phase Locked Loop) synthesizer 221 with a local oscillator 222, a radio frequency amplifier 223, an amplitude modulator 224, a control radio transmitter/receiver 225 and, optionally, a band-pass filter 226.

The piece of 5 GHz DVB-T transmitting equipment 109 209 is configured to receive the optical signal sent by the piece of optical extender equipment 105 205, detect it and again convert it into an intermediate frequency electric format. Likewise, the piece of transmitting equipment 109 209, using an analog image band rejection converter 220 directly converts the intermediate frequency signal into the 5 GHz free band, (a process which will be explained later), wherein said 5 GHz free band is the one specified in the ETSI EN 301 893 standard “Broadband Radio Access Networks (BRAN); 5 GHz high performance RLAN; Harmonized EN covering the essential requirements of article 3.2 of the R&TTE Directive”, which consists of the following frequency bands:

Band from 5150 MHz to 5350 MHz

Band from 5470 MHz to 5725 MHz

The system 100 200 also has a specific radio interface, called control radio interface 227, dedicated to the supervision and configuration of the pieces of equipment of the system 100 200. This specific interface is designed such that it has greater radio coverage and is more resistant to interferences and transmission errors than any of the remaining radio interfaces which are used in the system 100 200. This control radio interface 227 assures the remote supervision and configuration of the system 100 200 from the network of the telecommunications operator in any reasonable situation.

This control radio interface 227 allows implementing a specific communications channel independent from the radio interfaces used to support services. This specific communications channel is called control channel and is used for the control, configuration and supervision of all the pieces of equipment installed in the building. The control channel is managed from the radio access point or node 101 201, such that it is possible to control the pieces of client or intermediate equipment 102 202 from the latter.

As a result of the existence of the control channel and the fact that the radio access point or node 101 201 is connected to the access interface 107 207, the telecommunications operator can remotely control and supervise the operation of the system 100 200 in the installations of the client, regardless of the state in which the broadband radio interfaces used to support the services are.

The radio access point or node 101 201 performs the following functions: functions of transmission and reception (Tx/Rx) associated with the broadband radio interfaces, such as functions of detection and regeneration of the radio signals from the broadband radio interface and functions of transmission of signals to the broadband radio interface, using at all times the most suitable frequency band and standard; functions of transmission and reception (Tx/Rx) associated with a control radio interface, which is described in detail below; functions of routing of signals between the different broadband radio interfaces available in the piece of equipment; functions of gateway between the access interface 107 207 with the network of the operator and the optical extender (105 205 300); functions of cognitive radio by means of measuring the occupancy rate of different bands of the spectrum; functions of configuration of the pieces of equipment forming the system 100, supported by a control channel which will be described below; and functions of identification, by means of which the radio access point or node 101 informs the telecommunications operator, through the access interface 107 207, about its characteristics, pieces of equipment of the system which are connected thereto, radio technologies and the frequency bands used and the degree of occupation of the spectrum.

The system 100 200 also has a return channel between the 5 GHz DVB-T transmitter 109 209 and the piece of optical extender equipment 105 205, by means of a link over plastic optical fiber 108 228 between both pieces of equipment, of the analog or low-speed digital type. This return channel is an extension of the control channel described below, allowing the communication between the piece of client equipment 102 202 and the radio access node 101 201, such that the 5 GHz DVB-T transmitter 109 209 can communicate the information contained in the control radio interface from the piece of client equipment 102 202 to the piece of optical extender equipment 105 205 and from the latter to the radio access node 101 201.

The complete process followed by the signals in the downward direction (the one going from the access network to the piece of end equipment 103 203) is the following:
From the VHF/UHF DVB-T signals received by the access network in the Radio Access Node 101 201 or in the ONT, the optical extender 105 205 selects at least one DVB-T signal and converts it into a low intermediate frequency 217. This is performed by means of a very low-cost and general-purpose analog tuner 212 312. This process has a dual objective:

Selecting a limited number of DVB-T channels, since the radio spectrum availability in the 5 GHz free band is limited and it is not possible to simultaneously transmit all the VHF/UHF DVB-T channels which could be received from the access interface 107 207.

Adapting the frequency of the DVB-T signal to the bandwidth which can be supported by the transceivers for plastic optical fiber 215 216 218 219, normally limited to values of the order of 100 MHz for a few tens of meters, and which is not suitable for directly transmitting VHF/UHF DVB-T signals.
The intermediate frequency DVB-T signal 217 is used for the intensity modulation 213 of a light source suitable for its transmission over plastic optical fiber. This light source will typically be an LED (Light Emitting Diode) which will emit in the visible band of the optical spectrum, such as 660 nanometers for example, although the possibility of using sources of another type such as VCSELs (Vertical Cavity Surface-Emitting Lasers) is not excluded.
The intensity-modulated optical signal 229 is injected into a plastic optical fiber 208, typically of the step-index PMMA type. Since this fiber is not an electricity conductor, it can be installed in the same conduits used by the 220 volt cables of the building, which considerably reduces the deployment costs. The fiber is used to transport the modulated optical signal to the site in which the 5 GHz DVB-T transmitter 109 209 is installed, which can thus be placed in any site of the dwelling or building, regardless of where the Radio Access Node 101 201 and the optical extender 105 205 are located.
The intensity-modulated optical signal is received in the 5 GHz DVB-T transmitter 109 209, in which it is detected and returned to the intermediate frequency electric format by means of a PIN (Positive-Intrinsic-Negative) type photodetector.
In the 5 GHz DVB-T transmitter 109 209, once the optical signal has been detected and is in the intermediate frequency electric format, it is directly converted to the 5 GHz free band by means of a single analog mixer 220. This is done to reduce the number of radio frequency components necessary in the 5 GHz DVB-T transmitter 109 209. To perform the direct conversion from a low intermediate frequency, of the order of 36 MHz, to the 5 GHz band, a special mixed radio frequency implementation is performed, which is described below and which allows reducing the amplitude of the unwanted mixing component, also known as band image, by at least by 30 decibels for the purpose of reducing the need for radio frequency filtering to eliminate unwanted spurious signals.
In the 5 GHz DVB-T transmitter 109 209, the DVB-T signal converted to the 5 GHz band 230 is amplified and radiated by means of an antenna, for the reception therefore from the piece of Client Equipment 102 202.
In the piece of client equipment 102 202, the DVB-T signal in the 5 GHz band is detected, demodulated and delivered to the piece of end equipment 103 203 through the end equipment interface 104 204.

On the other hand, the complete process followed by the signals in the upward direction (the one going from the piece of Client Equipment 102 202 to the optical extender 105 205) is the following:
In the piece of Client Equipment 102 202, the Control Channel, supported by the Control Radio Interface 227, which among other possible embodiments can consist of a IEEE 802.15.4 type interface, although other possible implementations are not excluded, is transmitted.
This Control Radio Interface 227 is received in the 5 GHz DVB-T transmitter 109 209, which sends the information contained in the Control Channel to the optical extender 105 205 by means of the so-called Return Channel. The process for implementing this Return Channel in this invention consists of another optical link over plastic optical fiber 228. For this purpose, the 5 GHz DVB-T transmitter 109 209 has a LED diode or VCSEL laser type light source, in a manner similar to how it has been described for the optical extender 105 205 in the downward direction. The modulation of this light source is also an intensity modulation and can optionally be performed in a digital format of the, OOK type (On-off keying).
The optical extender 105 205 receives the Return Channel by means of the plastic fiber 108 228, detecting it by means of a PIN type photodetector. The information contained in the return channel also serves for the tuner 212 integrated in the optical extender 105 205 to select a determined VHF/UHF DVB-T channel for its conversion to intermediate frequency.

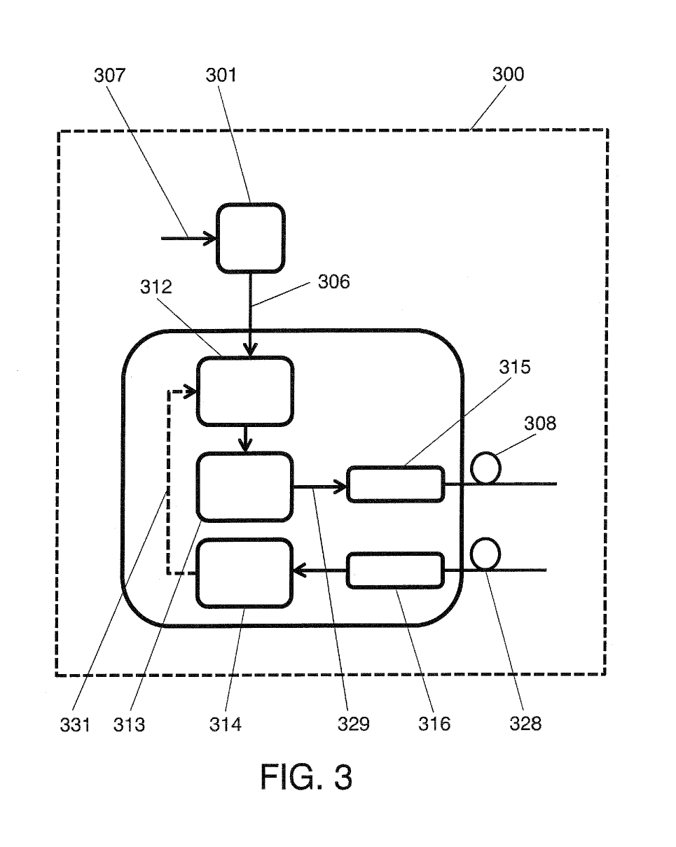

FIG. 3 shows a possible implementation of the optical device or piece of optical extender equipment 105 205 300 of the system. The main function of the optical extender 105 205 300 is to select at least one of the VHF/UHF DVB-T channels, convert it to intermediate frequency, and modulate with said intermediate frequency a light source which is injected into a plastic optical fiber 108 208 308 in the downward direction. Additionally, the optical extender 105 205 300 receives through another plastic fiber 108 228 328 in the upward direction a Return Channel allowing the control of the optical extender 105 205 300 from the piece of Client Equipment 102 202. The optical extender 105 205 300 comprises the following elements: an analog tuner 212 312, an amplitude modulator 213 313, a transmitter for plastic optical fiber 215 315, a receiver for plastic optical fiber 216 316 and a control module 214 314. The functions of each of these elements, as well as a preferred embodiment thereof, are described in detail below.

The function of the analog tuner 212 312 is to select at least one of the VHF/UHF DVB-T channels present in the multiplex delivered by the Radio Access Node 101 201 301, eliminating all the rest, and deliver at its output the selected channel converted to a lower intermediate frequency, typically 36 MHz. The conversion is performed in a completely analog manner by means of radio frequency mixers and local oscillators and at no time does it involve the extraction of the digital information contained in the DVB-T channel.

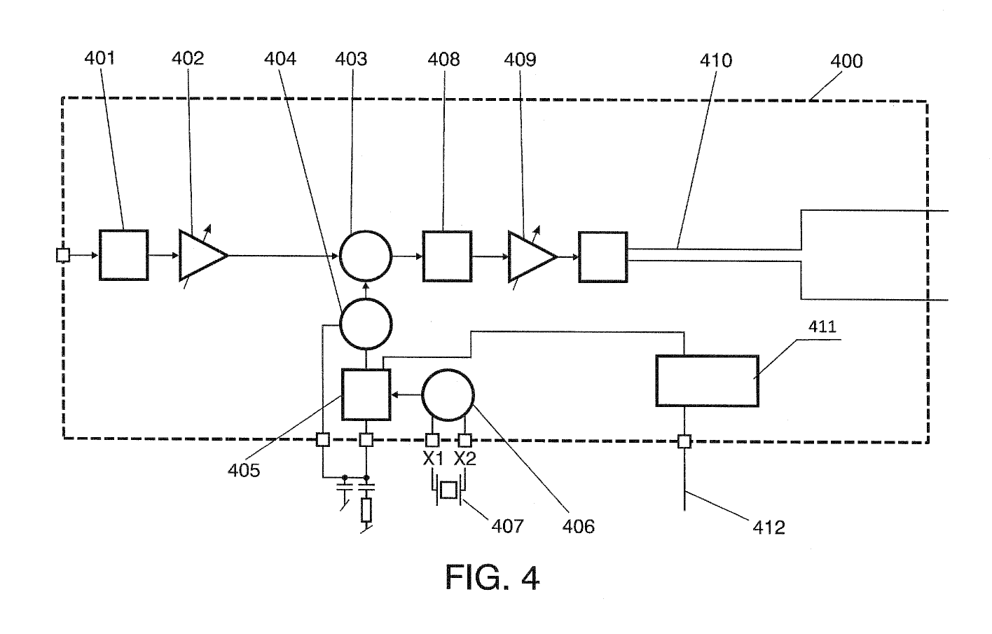

FIG. 4 shows a possible embodiment of the analog tuner 212 312 400. In this embodiment, the VHF/UHF DVB-T multiplex passes through a first band-pass filter 401, which can be tunable, and after being amplified 402 the filtered signal is injected into the radio frequency port of an analog mixer 403, whereas a signal of voltage-controlled local oscillator 404 synthesized by a PLL (Phase Locked Loop) circuit 405, from a reference oscillator 406, typically controlled by a crystal 407, is introduced through the local oscillator port of said mixer. The result of the mixing is an intermediate frequency DVB-T signal passing through a band-pass filter 408 to eliminate the image frequency from the mixing. The resulting filtered signal is amplified 409 and delivered in a differential format 410 at the output of the tuner.

The PLL circuit 405 is controlled from a PLL control element 411, which programs it to synthesize the necessary frequency of local oscillator 406. The necessary oscillator frequency is typically that which, upon being subtracted from the frequency of the VHF/UHF DVB-T channel which is to be selected, gives rise to an intermediate frequency equal to the central frequency of the band-pass filter 408 which is located after the mixer 403.

The PLL 405 is preferably programmed by means of a bus of the I2C type inter-integrated circuits and consists of indicating to the PLL 405 the division value that it must apply to the reference input signal and the division value that it must apply to the signal of the local oscillator 406. The PLL control element 411 receives instructions from the Tuner Control Interface 231 331 412, coming from the Control Module 214 314 of the optical extender 105 205 300. The tuner control interface 231 331 412 can also be of the I2C type, although any other type of embodiment is not ruled out.

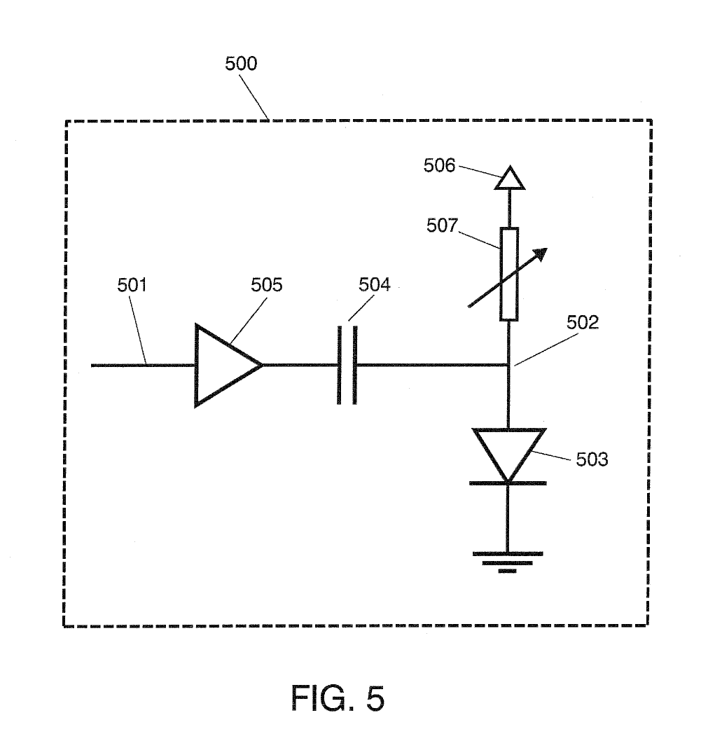

The function of the amplitude modulator 213 313 is that of varying the amplitude of the polarization current of the light source with the intermediate frequency signal delivered by the analog tuner 212 312 400. There are multiple ways of implementing this amplitude modulator 213 313. FIG. 5 describes a possible embodiment without excluding other possible implementations. In this possible embodiment, the amplitude modulator 213 313 500 consists of an amplification chain amplifying the level of the intermediate frequency DVB-T signal 501, which is coupled to the anode 502 of the LED diode 503 by means of a capacitor 504 which allows separating the direct current levels of the anode 502 of the LED 503 and of the output of the amplification chain 505. Between the anode 502 of the LED diode 503 and a positive voltage 506 there is placed a resistor 507, called a polarization resistor, which adjusts the medium current level polarizing the LED diode 503, which resistor 507 can be variable if the polarization current is to be adjusted.

The transmitter for plastic optical fiber 215 315 can be made in different ways, for example and without excluding other possibilities, by means of LED or VCSEL light sources. By way of an example, a possible embodiment is described which is based on a RC-LED (Resonant Cavity Light Emitting Diode) type which emits an optical signal in the 660 nanometer band. The optical signal of this RC-LED is modulated in its optical amplitude by means of the electric amplitude modulation of its polarization current, according to the technique known as “direct modulation”, which electric amplitude modulation is performed by the amplitude modulator element 213 313 500 described above. The RC-LED devices prepared to be analogically amplitude-modulated are typically polarized with polarization currents between 10 and 20 mA and inject a signal into the plastic optical fiber (typically, although without excluding other implementations of the step-index PMMA type, and with a Numerical Aperture value of 0.5) with a typical power between −10 and 0 dBm, with a spectral width between 15 and 30 nanometers, and have an electric bandwidth at 3 decibels of about 100 MHz.

The preferred embodiment of the receiver for plastic optical fiber 216 316 comprises a PIN type photodiode prepared to receive the optical signal of an optical length of about 660 nm delivered by a plastic optical fiber (typically, although without excluding other implementations, of the step-index PMMA type, and with a Numerical Aperture value of 0.5). Photodiodes of this type generally have a responsivity of 0.3 NW at the wavelength of 660 nm. For the application of reception of digitally modulated signals of the OOK type, as performed in the receiver module for optical fiber 216 316 of the optical extender 105 205 300, the rise and fall times of these photodetectors are of the order of 1 nanosecond, which allows them to have transmission rates of the order of 100 Mbit/s.

The function of the control module 214 314 comprised in the optical extender 105 205 300 is to receive the digital signal delivered by the receiver module for optical fiber 216 316, after the latter has detected the Return Channel supported by the plastic optical fiber in the upward direction 228 328. The information transported by the Return Channel and delivered to the control module 214 314 of the optical extender 105 205 300 can be of the following types:
Scanning initiation order, by means of which it is indicated to the optical extender 105 205 300 to initiate the scanning of the VHF/UHF DVB-T channels present in the input multiplex, for example from the channel with the lowest possible frequency. This order gives rise to the Control module 214 314, through the Control Interface 231 331 412 of the Tuner 212 312 400, indicating to the Tuner Control module 214 314 that it must program the PLL 405 to synthesize the suitable frequency of local oscillator 406.
Scanning continuation order, by means of which it is indicated to the optical extender 105 205 300 to tune a new channel of the VHF/UHF DVB-T multiplex. This order is the result of an indication of the user, through the User control interface 232, to continue the scanning of channels. This order gives rise to the Control Module 214 314, through the tuner control interface 231 331 412, indicating to the Tuner Control module 214 314 that it must program the PLL 405 to synthesize the following frequency of local oscillator 406.
Channel list generated in the piece of Client Equipment 102 202. As a result of the scanning process performed in the piece of Client Equipment 102 202, during which the user assigns determined names to each of the channels, a channel list is generated which is stored in the piece of Client Equipment 102 202 and which is sent to the optical extender 105 205 300. This list is stored in the Control Module 214 314 of the optical extender 105 205 300.
Tuning order for tuning a specific channel, by means of which it is indicated to the optical extender 105 205 300 to tune a determined channel of the VHF/UHF DVB-T multiplex. This order is the result of an indication of the user, through the User Control Interface 232, to display a determined channel in his piece of end equipment 103 203. This order gives rise to the Control Module 214 314 taking the channel list it has stored therein and, through the tuner control interface 231 331 412, indicating to the Tuner Control module 411 that it must program the PLL 405 to synthesize a specific frequency of local oscillator 406.

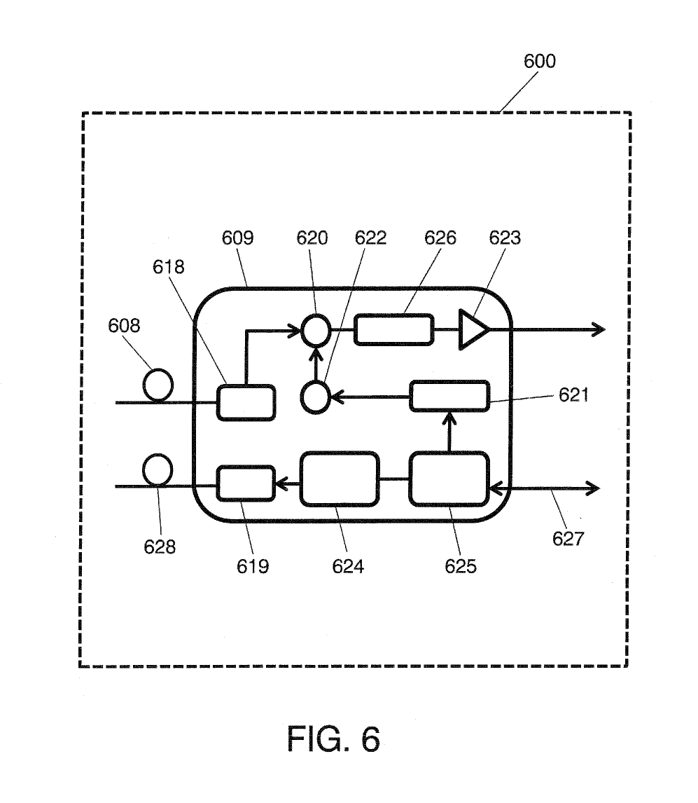

FIG. 6 shows a possible implementation of the 5 GHz DVB-T transmitter 109 209 600 of the system. The 5 GHz DVB-T transmitter 109 209 600 is a piece of equipment which receives an optical signal, transported by a plastic optical fiber in the downward direction, modulated with an intermediate frequency DVB-T signal, from the optical extender 105 205 300, and which, after converting it to an electric format, analogically converts it to the 5 GHz free band and radiates it by means of an antenna. Additionally, the 5 GHz DVB-T transmitter 109 209 600 detects the Control Radio Interface 227 627 from the piece of Client Equipment 102 202 and implements a Return Channel, supported by the upward plastic optical fiber 228 328 628, which allows communicating orders to the optical extender 105 205 300. The 5 GHz DVB-T transmitter 109 209 600 comprises the following elements: a receiver for plastic optical fiber 218 618, an image band rejection mixer 220 620, a PLL synthesizer 221 621 with a local oscillator 222 622, a radio frequency amplifier 223 623, an amplitude modulator 224 624, a transmitter for plastic optical fiber 219 619, a control radio transmission/reception module 225 625 and, optionally, a band-pass filter 226 626.

An embodiment of the receiver for plastic optical fiber 218 618 consists of a PIN type photodiode prepared to receive the optical signal of an optical length of about 660 nm delivered by a plastic optical fiber (typically, although without excluding other implementations of the step-index PMMA type, and with a Numerical Aperture value of 0.5). Photodiodes of this type typically have a responsivity of 0.3 A/W at the wavelength of 660 nm. For the application of reception of signals modulated by means of an intermediate frequency DVB-T signal, as performed in the receiver module for plastic optical fiber 218 618 of the 5 GHz DVB-T transmitter, the bandwidth at 3 decibels is of the order of 100 MHz.

The PLL synthesizer 221 621 is a device which allows synthesizing the desired frequency within a determined range. To that end, it has an internal frequency reference, typically a crystal oscillator, a voltage-controlled oscillator, called a local oscillator 222 622, a phase and frequency comparator, and a set of frequency dividers. When the PLL synthesizer 221 621 receives the order to synthesize a determined frequency from the control radio transmission/reception module 225 625, it programs its internal dividers so that the frequencies resulting from dividing the internal frequency reference and the desired frequency of local oscillator 222 622 are the same. The synthesized signal of local oscillator 222 622 is injected into the image band rejection mixer 220 620.

Optionally, the 5 GHz DVB-T transmitter 109 209 600 comprises a band-pass filter 226 626. The function of this band-pass filter 226 626 is that of eliminating the spurious signals from the image band rejection mixer 220 620. Spurious signals are understood as the signal of the local oscillator 222 622, the image band resulting from mixing the intermediate frequency DVB-T signal with the local oscillator 222 622, and any signal different from the 5 GHz DVB-T signal which is to be radiated. This band-pass filter 226 626 is used only in the event that a spurious rejection greater than offered to the image band rejection mixer 220 620 is desired.

The function of the radio frequency amplifier 223 623 of the 5 GHz DVB-T transmitter 109 209 600 is to raise the level of the 5 GHz DVB-T signal to the suitable power and deliver it to the antenna from which it must be radiated. According to the ETSI EN 301 893 standard, the maximum power which can be radiated in the 5 GHz free band will depend on the frequency used and, therefore, if power control techniques are not applied, it has the following values:
In the band from 5150 MHz to 5250 MHz, 23 dBm, and 10 dBm/MHz
In the band from 5250 MHz to 5 350 MHz, 20 dBm, and 7 dBm/MHz
In the band from 5470 MHz to 5725 MHz, 27 dBm, and 14 dBm/MHz

The implementation of the radio frequency amplifier 223 623 can be performed in multiple ways, considering the criterion of preserving the integrity of the 5 GHz DVB-T signal which it delivers at its output, measured according to the parameter of spectral mask compliance, as shown in document ETSI EN 300 744 in its section 4.8 “Spectrum characteristics and spectrum mask”, and the criterion of minimum possible consumption. Among the possible implementations, a class A amplifier, a class AB amplifier, or an amplifier linearized by means of techniques such as feedforward or of a Doherty type amplifier can be used, although any other from of implementation is not ruled out.

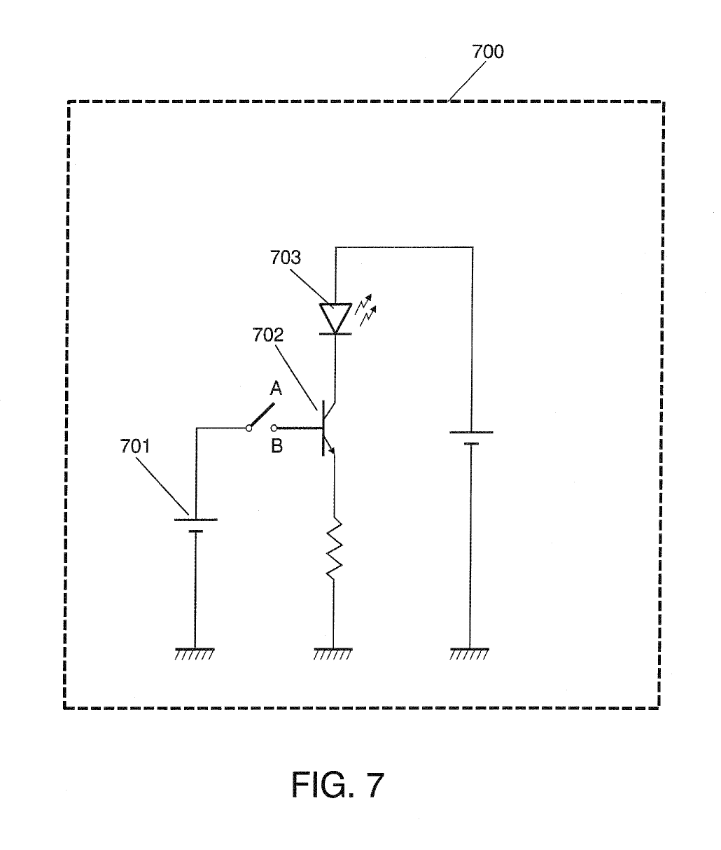

FIG. 7 shows the diagram of a possible embodiment of the amplitude modulator 224 624 700 of the 5 GHz DVB-T transmitter, without this serving to limit other possible embodiments. The function of the amplitude modulator 224 624 700 is that of varying the amplitude of the polarization current of the light source with the digital signal delivered by the control radio transmission/reception module 225 625. In this possible embodiment, the amplitude modulator 224 624 700 consists of the polarization in open circuit or with a determined voltage 701 of the base of a transistor 702, which in turn controls the collector current of said transistor 702, which is equal to the polarization current of the LED diode 703.

The transmitter for plastic optical fiber 219 619 of the DVB-T transmitter, like the transmitter of the piece of optical extender equipment 215 315 already described, can be made in different ways, for example and without excluding other possibilities, by means of LED or VCSEL light sources. By way of an example, a possible embodiment is described which is based on an RC-LED type source which emits an optical signal in the 660 nanometer band. The optical signal of this RC-LED is modulated in its optical amplitude by means of the electric amplitude modulation of its polarization current, according to the technique known as “direct modulation”, which electric amplitude modulation is performed by the element amplitude modulator 224 624 700 already described. The RC-LED devices prepared to be analogically amplitude-modulated are typically polarized with polarization currents between 10 and 20 mA and inject a signal into the plastic optical fiber (typically, although without excluding other implementations, of the step-index PMMA type, and with a Numerical Aperture value of 0.5) with a typical power between −10 and 0 dBm, with a spectral width between 15 and 30 nanometers, and have an electric bandwidth at 3 decibels of about 100 MHz.

The control radio transmission/reception module 225 625 allows the communication between the DVB-T transmitter and the piece of client equipment. This module controls the synthesizer of a local oscillator 222 622 by means of a PLL 221 621, and generates a digital type return channel which is delivered to the amplitude modulator 226 624 and which is transmitted by the upward plastic optical fiber 228 628. The control radio transmission/reception module 225 625 communicates with the PLL synthesizer module 221 621, for example, but without excluding other possible embodiments, by means of an I2C type interface, and indicates to it which frequency of local oscillator 222 622 must be synthesized. The frequency of local oscillator 222 622 which must be synthesized is calculated by the control radio transmission/reception module 225 625 based on the information from the control radio interface 227 627. The control radio interface 227 627 supports a control channel which, among other functions, has the function of indicating at which specific frequency of the 5 GHz free band the 5 GHz DVB-T signal must be transmitted. The frequency of local oscillator 222 622 which must be synthesized in the PLL synthesizer 221 621 will be that which, upon being mixed with the intermediate frequency DVB-T signal, results in the 5 GHz DVB-T signal at the desired frequency of the 5 GHz free band.

The information contained in the return channel and delivered to the amplitude modulator 224 624, can be of the following types:
Scanning initiation order, by means of which it is indicated to the optical extender 105 205 300 to initiate the scanning of the VHF/UHF DVB-T channels present in the input multiplex.
Scanning continuation order, by means of which it is indicated to the optical extender 105 205 300 to tune a new channel of the VHF/UHF DVB-T multiplex. This order is the result of an indication of the user, through the user control interface 232, to continue the scanning of channels.
Channel list generated in the piece of client equipment 102 202. As a result of the scanning process performed in the piece of client equipment 102 202, during which the user assigns determined names to each of the channels, a channel list is generated which is stored in the piece of client equipment 102 202 and in the 5 GHz DVB-T transmitter 109 209 600 and which is sent to the optical extender 105 205 300. In the 5 GHz DVB-T transmitter 109 209 600, this list is stored in the control radio transmission/reception module 225 625.
Tuning order for tuning a specific channel, by means of which it is indicated to the optical extender 105 205 300 to tune a determined channel of the VHF/UHF DVB-T multiplex. This order is the result of an indication of the user, through the user control interface 232, to display a determined channel in his piece of end equipment 203.

The DVB-T transmitter 109 209 600 implements a direct conversion of the intermediate frequency DVB-T signal, typically centered in 36 MHz, to the 5 GHz free band, for the purpose of reducing the number of elements necessary in the piece of equipment, and thus the cost. However, the usual process for passing from a signal at a low frequency, such as 36 MHz, to a high frequency such as 5 GHz, consists in performing a double frequency conversion; the first one changes the intermediate frequency centered in 36 MHz to another higher one, such as 800 MHz for example, and the second one transforms the latter to the 5 GHz band. The two-step conversion prevents the great difficulty in filtering the image frequency of the conversion, which would be separated from the desired signal by a value which is only twice the value of the input intermediate frequency, for example 36 MHz×2=72 MHz, in the event of performing a direct conversion. On the other hand, the embodiment of the two-step conversion has the advantage that the image band is much farther away, for example 800 MHz×2=1,600 MHz, such that it can be easily filtered and eliminated, but has the drawback of increasing the cost of the system since two frequency synthesizers, two mixers and the corresponding filters are necessary.

The system of the invention 100 200 use a single-step conversion structure, using quadrature mixers for attenuating the unwanted image band or sideband resulting from the mixing, thus eliminating the need to perform subsequent filterings for the elimination thereof.

Without ruling out any other embodiment, two possible preferred embodiments which are detailed below are described. Both embodiments are based on using two mixers and on creating quadrature replicas of the signals. In the first embodiment, two replicas of the intermediate frequency DVB-T signal, with equal amplitude and a 90° phase difference (intermediate frequency quadrature DVB-T signals) are created, whereas in the second embodiment two replicas of the signal of the local oscillator, with equal amplitude and a 90° phase difference (quadrature local oscillators) are created. In both embodiments the degree of cancellation of the image band depends on the precision of the phase shift (with respect to the ideal 90° phase shift) and on the equality of amplitude of the two quadrature signals, which must be performed for the entire bandwidth of the DVB-T signal, typically 8 MHz. The cancellation of the unwanted sideband which is achieved is calculated by the following formula:

$$L ( dB ) = 10 \cdot log ( \frac{1 - 2 \cdot {K}_{m} \cdot {K}_{s} \cdot cos ( {φ}_{m} + {φ}_{s} ) + {K}_{m}^{2} \cdot {K}_{s}^{2}}{1 + 2 \cdot {K}_{m} \cdot {K}_{s} \cdot cos ( {φ}_{m} + {φ}_{s} ) + {K}_{m}^{2} \cdot {K}_{s}^{2}} )$$

where:
L(dB) is the attenuation in decibels of the unwanted sideband.
Ks is the amplitude difference between the two quadrature signals. Depending on the implementation, these quadrature signals can be the intermediate frequency quadrature DVB-T signals, or the quadrature 5 GHz DVB-T signals.
Km is the amplitude difference of the quadrature local oscillator.
φs is the error in the phase difference of the signal. Depending on the implementation, these quadrature signals can be the intermediate frequency quadrature DVB-T signals, or the quadrature 5 GHz DVB-T signals.
φm is the error in the phase difference of the quadrature local oscillator.

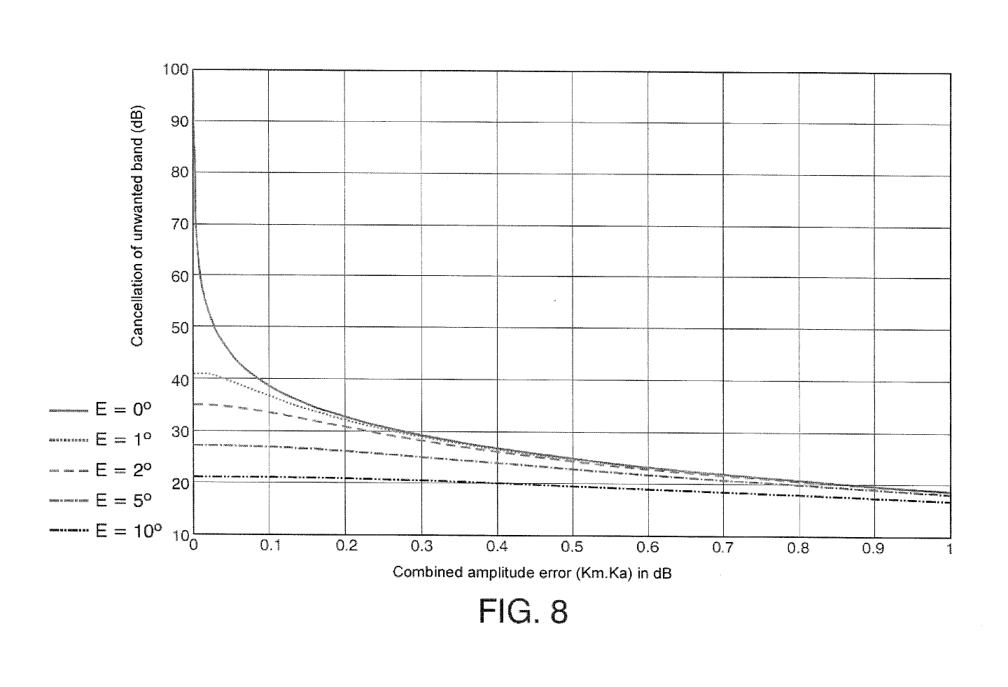

FIG. 8 shows the graphic representation of the attenuation of the unwanted sideband for the case in which the amplitude errors of the signal and of the local oscillator (Km×Ks) and the phase errors of both (φm+φs) are combined.

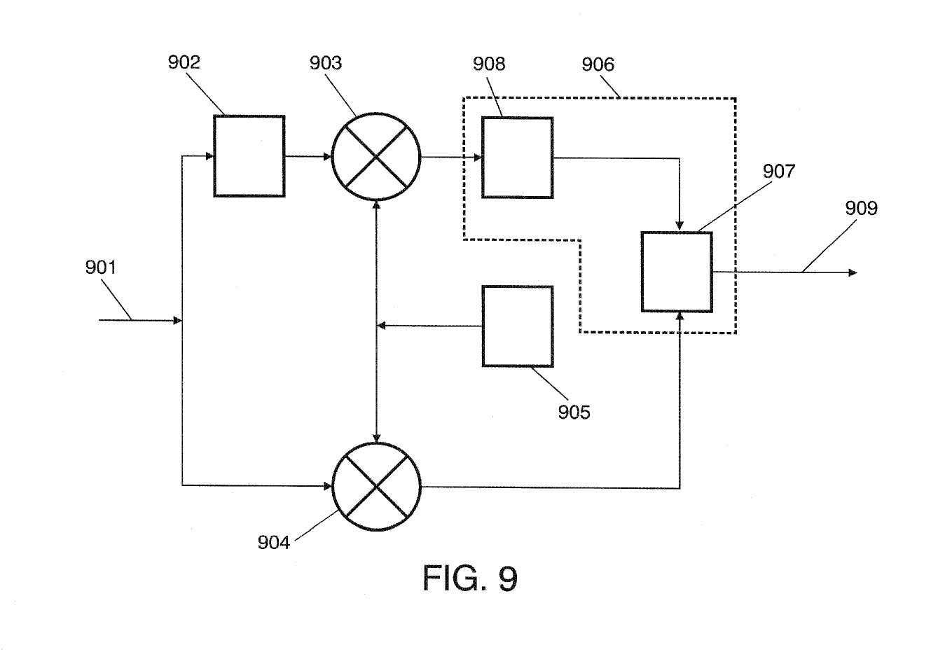

FIG. 9 shows in detail one of the two possible embodiments of the image band rejection converter 220 620. This implementation is based on intermediate frequency quadrature DVB-T signals 901 and consists of performing the phase shift of the intermediate frequency DVB-T signal (for example at 36 MHz). This implementation has the feature that the bandwidth of the DVB-T signal (8 MHz) relative to the central frequency of 36 MHz is high and it is therefore more difficult to achieve the quadrature of the signals but, however, it has the advantage that at low frequencies it is possible to perform adjustments in a simple manner. In FIG. 9, the block 902 shifts the phase of the input signal by 90°, the blocks 903 and 904 are mixers, 905 is a local oscillator, 906 is a 90° hybrid formed by a block which shifts the phase of the signal by 90° 908 and an adder 907.

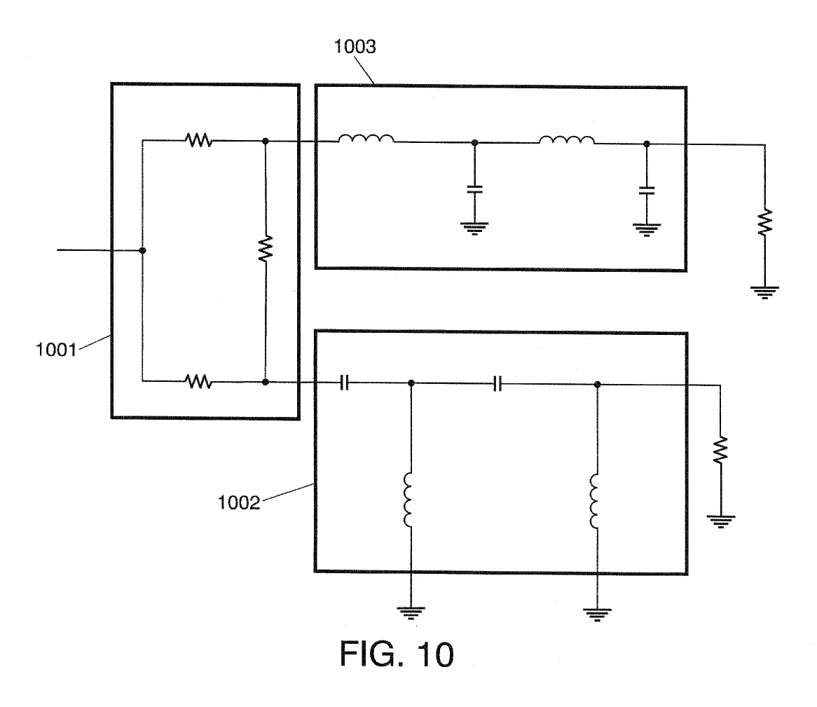

FIG. 10 illustrates how, in order to perform the correct phase shift of the intermediate frequency DVB-T signal, a structure is used which is formed by a resistive divider 1001 dividing the DVB-T signal in two, and two Bessel type filters 1002 1003, one of them a high-pass filter 1002 and the other one a low-pass filter 1003, are fed with each of these signals. The main feature of the Bessel filters is that the phase is linear in the entire pass band thereof, and furthermore the delay that they introduce is constant for all the frequencies.

In the present embodiment, the cut-off frequencies of the Bessel filters 1003 1003 have been chosen such that the cut-off frequency of the high-pass filter 1002 is much lower than the 36 MHz of the intermediate frequency DVB-T signal, and the cut-off frequency of the low-pass filter 1003 is much greater than that of 36 MHz of the intermediate frequency DVB-T signal, such that the amplitude error in the bandwidth of the DVB-T signal, typically 8 MHz, is very reduced, whereas the phase difference between the two branches is maintained approximately at 90°.

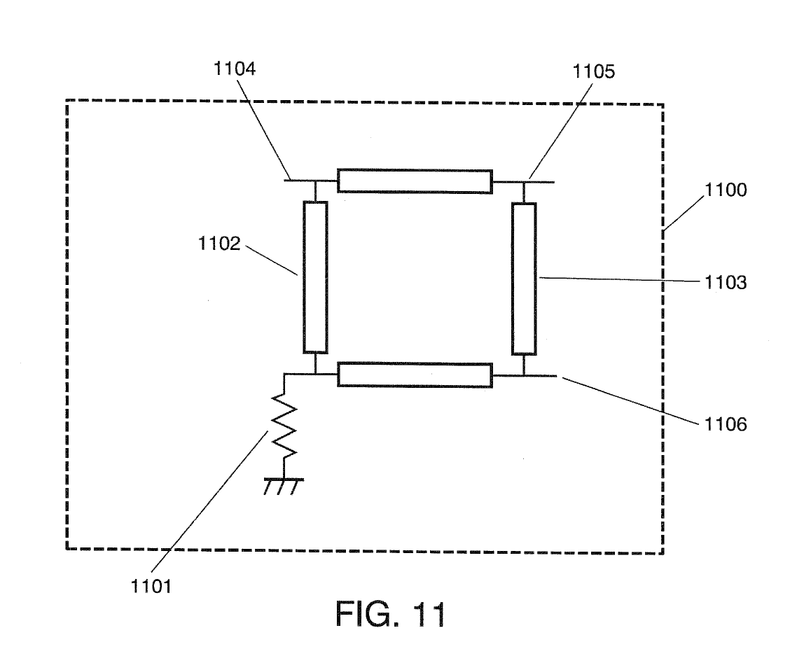

According to the diagram of FIG. 9, to achieve the cancellation it is also necessary to perform a 90° phase shift 908 in one of the branches after one of the mixers 903 and an addition 907 of the quadrature 5 GHz DVB-T signals. This is performed by means of a single device, shown in FIG. 11, called 90° hybrid 906 1100 which is implemented by means of printed circuit tracks according to a technique known as branch-line, wherein Z0 1101 1102 1103 is the characteristic impedance, equal to 50 ohms, the “input” port 1104 corresponds with the point 909 in FIG. 9, and the ports referred to as “port 2” 1105 and “port 3” 1106 correspond to the outputs of the mixers 903 904 in FIG. 9. In relation to the length of the four branches of the 90° hybrid, each of them is equal to a quarter of the wavelength of the 5 GHz DVB-T signal, centered in the frequency of 5250 MHz in the embodiment.

By way of an example, the performance of this embodiment with the following values has been evaluated:

| | | | | |
|---|---|---|---|---|
| Resistive divider | R1, R2 | 51 Ω | R3 | 100 Ω |
| Low-pass | L1 | 18 nH | L2 | 82 nH |
| | C1 | 27 pF | C2 | 82 pF |
| High-pass | L3 | 910 nH | L4 | 220 nH |
| | C3 | 910 pF | C4 | 270 pF |

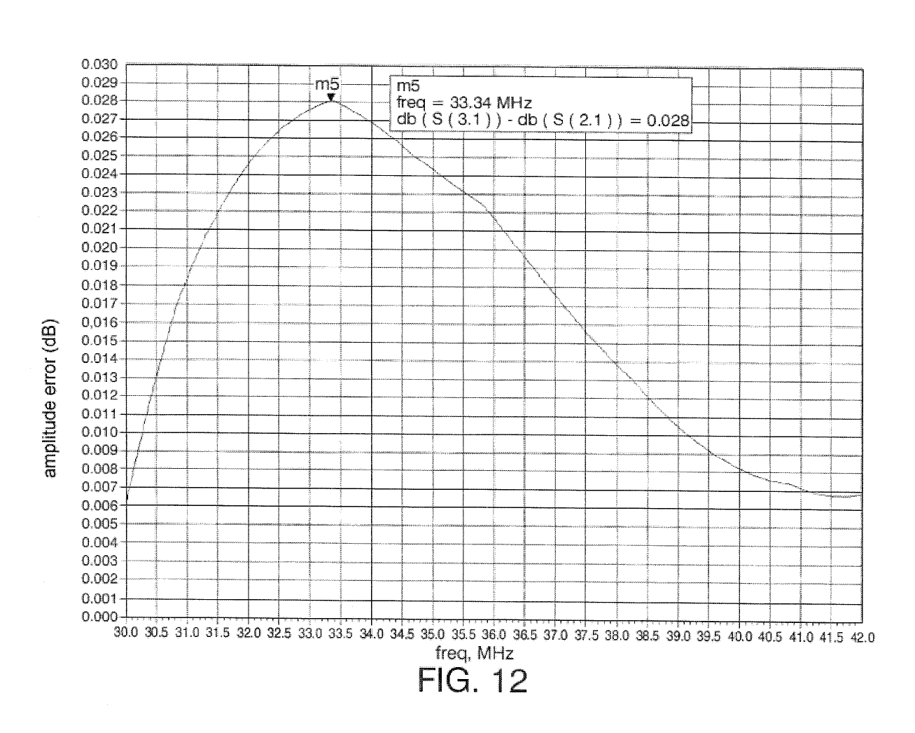

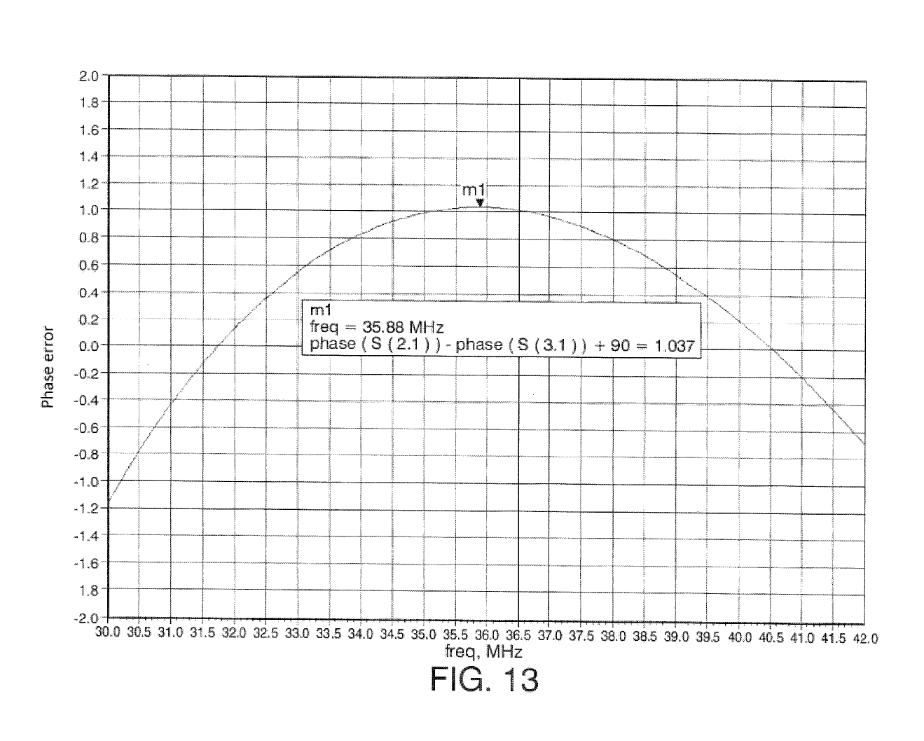

For the implementation of the branch-line 90° hybrid 906 1100, a microstrip type line on a glass fiber substrate with a dielectric constant of 4.6 and a thickness of 0.8 mm is used. All the adverse effects of the attachments of the different quarter-wave segments are taken into account. FIGS. 12 and 13 show the results obtained. As can be observed in said figures, for a DVB-T signal at a frequency centered in 36 MHz, and with a bandwidth of 8 MHz, the worst phase error is approximately 1° and amplitude error less than 0.03 dB, so the cancellation of the unwanted image band is greater than 40 dB.

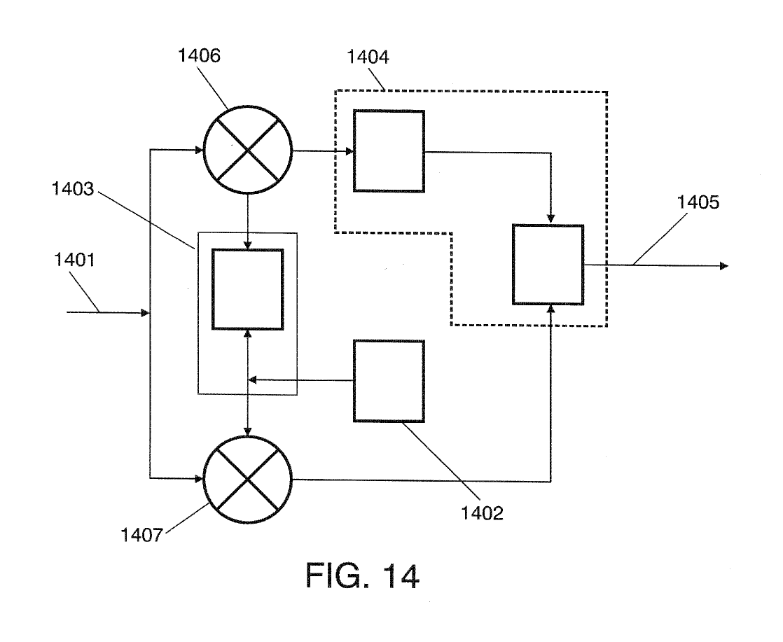

FIG. 14 shows the second of the two possible preferred embodiments for the image band rejection converter 220 620. This implementation is based on quadrature signals of the local oscillator and consists of performing the phase shift of the DVB-T signal in the 5 GHz band 1401 and in the local oscillator 1402. To achieve the correct phase shift of the signal of local oscillator 1402, and of the 5 GHz DVB-T signal 1401 of the upper branch, two 90° hybrids 1403 1404 are used, implemented on a printed circuit by means of the branch-line technique according to the diagram of FIG. 11.

In this possible embodiment, and for the hybrid 1404 performing the phase shift of the 5 GHz DVB-T signal 1401, the “input” port 1104 corresponds with the point 1405 in FIG. 14, and the ports referred to as “port 2” 1105 and “port 3” 1106 correspond to the outputs of the mixers 1406 1407 in FIG. 14.

In relation to the hybrid performing the phase shift of the signal of the local oscillator, the “input” port 1104 corresponds with the point 1402 in FIG. 14, and the ports referred to as “port 2” 1105 and “port 3” 1106 correspond to the inputs of the mixers 1406 1407 in FIG. 14.

In relation to the length of the four branches of each of the 90° hybrids 1403 1404, each of them is equal to a quarter of the wavelength of the 5 GHz DVB-T signal, centered in the frequency of 5250 MHz in the embodiment.

For the implementation of the branch-line 90° hybrids 1403 1404, microstrip type lines on a glass fiber substrate with a dielectric constant of 4.6 and a thickness of 0.8 mm are used. All the adverse effects of the attachments of the different quarter-wave segments are taken into account.

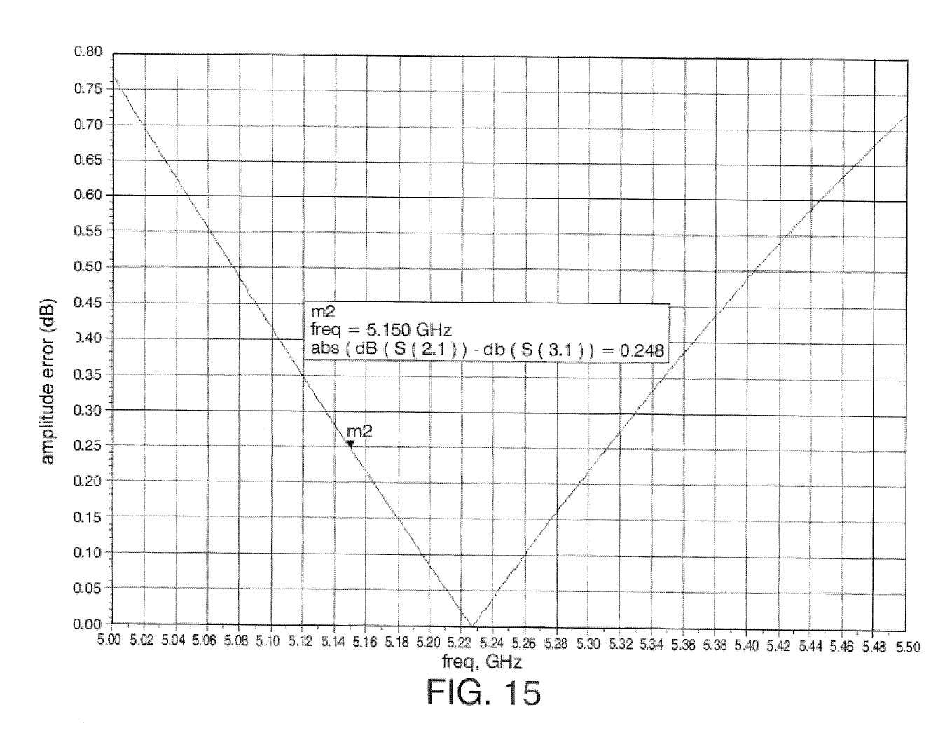

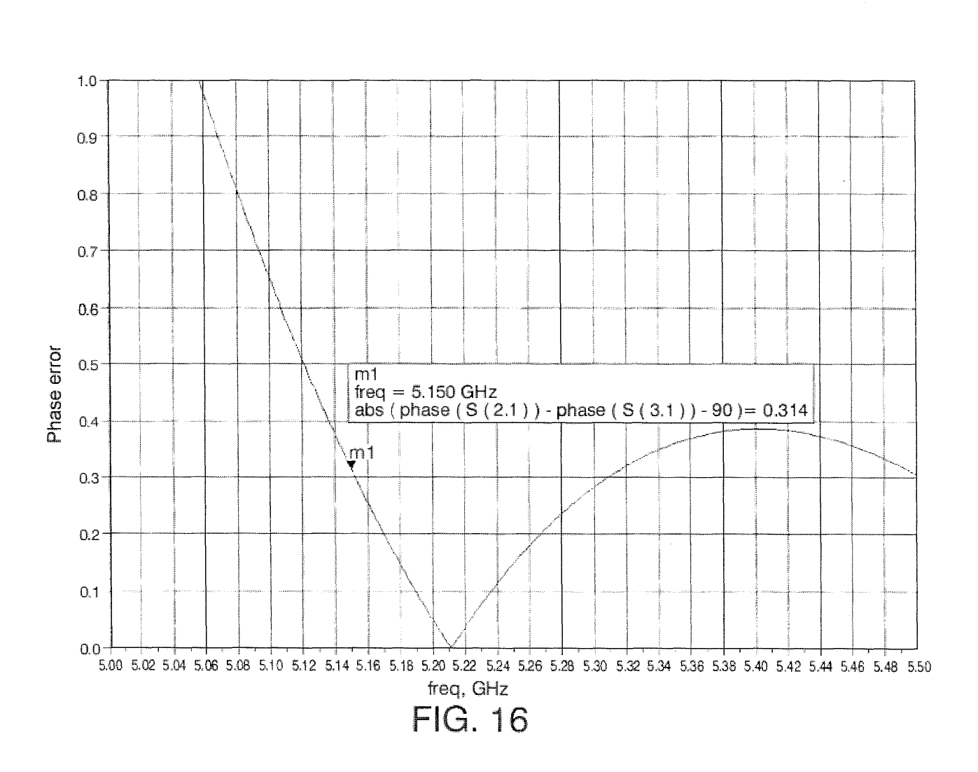

The results obtained are depicted in FIGS. 15 and 16. Based on these results, an attenuation of the unwanted image band of 31 dB is achieved for the entire band going from 5150 MHz to 5350 MHz.

Without excluding the possibility of using plastic fibers of another type, the preferred embodiment of this invention seeks to minimize the cost of deploying the system 100 200, therefore it is based on using step-index type (PMMA, polymethyl methacrylate) type fiber, with a core of 980 micrometers in diameter and a typical refractive index of 1.49, and a cladding with a diameter of 1 mm and a typical refractive index of 1.46, the typical numerical aperture being 0.5.

The system 100 200 of the invention further comprises a specific radio interface radio called control radio interface 227 627 which gives support to a control channel used for the tasks of managing the entire system and which preferably serves to support a channel which allows, from the piece of client equipment 102 202, selecting the audio and video signals which will be sent by the broadband radio interface from the 5 GHz DVB-T transmitter 109 209 600.

This text furthermore introduces a novelty in the implementation of the control radio interface 227 627, consisting of a mechanism so that the information contained in the control channel reaches from the 5 GHz DVB-T transmitter 109 209 600 to the radio access node 101 201. To that end, the present invention comprises a return channel, supported by a PMMA type plastic fiber, between the 5 GHz DVB-T transmitter 109 209 600 and the optical extender 105 205 300.

The control process is based on the fact that the piece of client equipment 102 202 incorporates an interface called the user control interface 232. This interface is used so that the user can select from the piece of client equipment 102 202, which will be connected to the piece of end equipment 103 203 which will generally be a television set, the audio and video signals to be delivered to his piece of end equipment 103 203. This is necessary because the radio access node 101 201 can receive multiple audio and video signals through the access interface 107 207, but only those contents selected by the user will be emitted from the 5 GHz DVB-T transmitter 109 209 600 through the broadband radio interface, for the purpose of only using the radio spectrum that is strictly necessary. Thus, once the user selects the signals which he wishes to be sent to his piece of end equipment 103 203, this selection is transmitted from the piece of client equipment 102 202 to the 5 GHz DVB-T transmitter 109 209 600, and from the latter to the optical extender 105 205 300 by means of the control radio Interface 227 and of the return channel respectively.

More specifically, the process allowing the selection of audio and video signals from the piece of client equipment 103 203 is the following:

In a first phase, the optical extender 105 205 300 performs a scanning of all the audio and video signals that it receives through the access interface 107 207. By way of an example, and without excluding other possible embodiments, the optical extender 105 205 300 sequentially tunes all the channels of a VHF/UHF DVB-T multiplex and transmits them sequentially over time, by means of the plastic optical fiber, to the 5 GHz DVB-T transmitter 109 209 600. The 5 GHz DVB-T transmitter 109 209 600 in turn wirelessly sends these channels to the piece of client equipment 102 202, which sequentially delivers them to the piece of end equipment 103 203. As this scanning is performed, the user can see in his piece of end equipment 103 203 (television set) the audiovisual contents which are being sent and, through the user control interface 232, he can register in the piece of client equipment 103 203 information about the programs received, for example the trade name of each of them. In a mode detailed manner, and without ruling out other possible implementations, the process consists of the following:
The optical extender 105 205 300 adjusts the frequency of the internal local oscillator 406 to select the first possible channel of the VHF/UHF multiplex (for example, the lowest possible frequency).
The resulting intermediate frequency signal is transmitted by the fiber in the downward direction, received by the DVB-T transmitter 109 209 600 and radiated in the 5 GHz band, detected by the piece of client equipment 102 202 and finally displayed in the piece of End Equipment 103 203.
The user sees the content and assigns a name to it by means of the User Control Interface 232, which name is registered in the piece of client equipment 103 203.
The user indicates, by means of the user control interface 232, that it can continue scanning the VHF/UHF DVB-T multiplex. This scanning continuation order is transmitted from the piece of client equipment 102 202 to the 5 GHz DVB-T transmitter 109 209 600 by means of the control radio interface 227, and from the 5 GHz DVB-T transmitter 109 209 600 to the optical extender 105 205 300 by means of the return channel, the latter being supported by the plastic optical fiber 228 328.
When the optical extender 105 205 300 receives the scanning continuation order, or after waiting a pre-established time in the event that there is no indication of continuing the scanning, it repeats the process with the following possible VHF/UHF DVB-T channel of the input multiplex.

Once the process is completed for all the VHF/UFH DVB-T channels of the multiplex, the piece of client equipment 102 202 generates a complete list of the channels received, which list is also sent to the optical extender 105 205 300, through the control radio interface 228 and the return channel, in which this information is also registered.

Next, when the user wishes to receive a determined audiovisual content in his piece of end equipment 103 203, typically a television set, he connects to the piece of client equipment 102 202 by means of the user control interface 232 and requests the previously registered information about the available programs. This information can be displayed to the user through the user control interface 232 and be viewed in the device connected to this user control interface 232, or be displayed to the user through the end equipment interface 104 204 to be viewed in the piece of end equipment 103 203, which can be a television set by way of an example. Once the user has selected the content which he wishes to be delivered, this information is transmitted by means of the control radio interface 227 627 to the 5 GHz DVB-T transmitter 109 209 600, and from the latter to the optical extender 105 205 300 by means of the return channel. With this information, the optical extender 105 205 300 tunes and sends the VHF/UHF DVB-T channel selected by the user.

The system of the invention 100 200 includes a plastic fiber section and a completely analog transmitting unit, which provides it with the following advantages with respect to the already existing wireless solutions:
The plastic optical fiber section allows installing the piece of transmitting equipment which distributes the wireless audio and video signal (the 5 GHz DVB-T transmitter 109 209 600) at any point of the home or office, thus allowing separating the point from which the signal is radiated from the point reached by the access network, thus optimizing the wireless coverage of the home or office.
The plastic optical fiber section allows using the same conduit for its laying as that used by the electric power cables, which reduces the deployment costs and prevents performing any building work in the home or office.
The PMMA type plastic fiber section, with a diameter of 1 mm, can be installed by an unqualified technician or by the user himself, since the tools to be used are simple and it can be identified which fiber transports optical signal in a visual manner, since the 660 nm signal is visible in the red area of the spectrum.
The plastic optical fiber section, including the actual fiber and the optical transceivers, has low equipment costs, lower than any other fiber-based solution.
The optical extender 105 205 300 implements a low-cost architecture, since for the selection of the VHF/UHF DVB-T channel to be transmitted it uses a standard commercial tuner used in any DVB-T receiver. The intermediate frequency DVB-T signal delivered by the tuner 212 312, typically at 36 MHz, can in turn be directly transmitted by an optical transmitter 215 315 over the plastic fiber.
The optical extender 105 205 300 does not need any digital processing of the DVB-T signal, which reduces the costs of material and operation of the piece of equipment.
The 5 GHz DVB-T transmitter 109 209 600 implements a very low-cost architecture, since:

For the conversion of the intermediate frequency DVB-T signal at 36 MHz to the 5 GHz free band it uses a simple analog mixing with a local oscillator 222 622, which involves using low-cost analog components.

The conversion of intermediate frequency at 36 MHz to the 5 GHz band is performed in a single step, instead of the usual process of passing from the intermediate frequency of 36 MHz to a second higher frequency, and from the latter to the 5 GHz free band. The single-step conversion saves in material costs.

The single-step conversion of intermediate frequency at 36 MHz to the 5 GHz band is performed by means of a mixer 220 620 rejecting the image band of the mixing, which reduces the needs for subsequent filtering, thus saving in costs.
The 5 GHz DVB-T transmitter 109 209 600 does not require any digital processing of the DVB-T signal, which reduces the material and operation costs of the piece of equipment.
The implementation of a return channel between the 5 GHz DVB-T transmitter 109 209 300 and the optical extender 105 205 300, supported by a plastic optical fiber, allows the orders of the user about the channels that he wishes to see to always reach the optical extender 105 205 300, regardless of the distance separating both pieces of equipment.

1-8. (canceled)

9. A system for distributing broadband wireless signals indoors, comprising:
a radio access node connected to a telecommunications access network through an access interface, wherein said radio access node comprises a broadband signal transmission/reception module configured to transmit and receive VHF/UHF DVB-T broadband wireless signals through a broadband radio interface;
at least one piece of client equipment comprising a broadband signal transmission/reception module configured to transmit and receive VHF/UHF DVB-T broadband wireless signals through a broadband radio interface in the 5 GHz free band, wherein said 5 GHz free band is the one specified in the ETSI EN 301 893 standard;
characterized in that said system further comprises:
at least one optical device configured to: receive broadband signals from said radio access node, select at least one broadband signal from said radio access node, convert said broadband signal into an optical signal and transmit said optical signal through a link over plastic optical fiber;
at least one transmitting device configured to: receive and detect an optical signal from said at least one optical device through said link over plastic optical fiber, convert said optical signal in a DVB-T signal in the 5 GHz free band and transmit it through a broadband radio interface in the 5 GHz free band.

10. The system of claim 9, further comprising:
a control channel configured to exchange control signals between said at least one piece of client equipment and said at least one piece of transmitting equipment over a control radio interface, each of said pieces of client equipment and at least one piece of transmitting equipment comprising a control signal transmission/reception module configured to set up said control channel for transmitting and receiving wireless signals over said control radio interface;
a return channel configured to exchange the information contained in said control signals between said at least one piece of transmitting equipment and said at least optical device, each of said pieces of transmitting equipment and at least one optical device comprising an optical signal transmission/reception module configured to set up said return channel over a link over optical fiber; and
a user control interface in said at least one piece of client equipment which allows a user to select from said at least one piece of client equipment a determined channel from those contained in the signal received by the radio access node.

11. The system according to claim 9, wherein said at least one piece of client equipment is connected to a piece of end equipment through an end equipment interface, said piece of client equipment being configured to provide said piece of end equipment with at least one communications service through said end equipment interface.

12. The system according to claim 9, wherein said control signals transmitted over said control channel contain at least one of the following types of information:
a scanning initiation order, indicating to the optical device to initiate a scanning of channels contained in the signal received by the radio access node;
a scanning continuation order, indicating to the optical device to tune a new channel, wherein said scanning continuation order is indicated by a user through the user control interface;
a channel list generated in the piece of client equipment, wherein said channel list is stored in the piece of client equipment and in the control signal transmission/reception module of the piece of transmitting equipment and is sent to the optical device;
a tuning order for tuning a specific channel, indicating to the optical device to tune a determined channel from those contained in the signal received by the radio access node, wherein said tuning order is indicated by a user through the user control interface.

13. The system according to claim 9, wherein said optical device is connected to said radio access node by means of a cable, as an insertable module or as a functional unit integrated in said radio access node.

14. The system according to claim 9, wherein said optical device comprises:
an analog tuner, configured to select at least one of the channels included in the broadband signal delivered by the radio access node and deliver at its output a signal comprising said selected channel converted to a determined intermediate frequency;
an amplitude modulator, configured to vary the amplitude of the polarization current of a light source with said signal converted to an intermediate frequency delivered at the output of said analog tuner;
a transmitter for plastic optical fiber, configured to transmit an optical signal from said light source modulated with said amplitude modulator over a link of plastic optical fiber;
a receiver for plastic optical fiber, configured to receive an optical signal delivered by a link over plastic optical fiber and detect the information contained in said return channel;
a control module, configured to receive a digital signal from said receiver for optical fiber and transmit said information to said analog tuner over a tuner control interface.

15. The system according to claim 9, wherein said transmitting device comprises:
a receiver for plastic optical fiber, configured to receive an optical signal delivered by a link over plastic optical fiber, detect said optical signal and convert it into an electric signal at a determined intermediate frequency;
an image band rejection mixer, configured to convert said signal at a determined intermediate frequency into a DVB-T signal in the 5 GHz free band;
a phase locked loop synthesizer with a local oscillator, configured to generate a signal, synthesize a determined frequency for said signal and inject said signal into the input of said image band rejection mixer;
a radio frequency amplifier, configured to raise the amplitude of said DVB-T signal in the 5 GHz free band;
a control signal transmission/reception module, configured to set up the return channel and manage said phase locked loop synthesizer with said local oscillator;
an amplitude modulator configured to vary the amplitude of the polarization current of a light source with a signal delivered by said control signal transmission/reception module;
a transmitter for plastic optical fiber, configured to transmit an optical signal from said light source modulated with said amplitude modulator over a link of plastic optical fiber.

16. The system according to claim 15, wherein said transmitting device further comprises a band-pass filter, configured to eliminate the signals of the local oscillator and the resulting image band of the output of said image band rejection mixer.
